(19) United States
(12) Patent Application Publication
(10) Pub. No.: US 2012/0307044 A1
(43) Pub. Date: Dec. 6, 2012

(54) LEAK DETECTION APPARATUS FOR BLISTER PACKS

(75) Inventor: Charles Alban Barker, St Ives Huntingdon (GB)

(73) Assignee: SEPHA LIMITED, Belfast Antrim (GB)

(21) Appl. No.: 13/578,296

(22) PCT Filed: Feb. 7, 2011
(86) PCT No.: PCT/GB11/50207

§ 371 Date: Aug. 10, 2012

(30) Foreign Application Priority Data
Feb. 11, 2010 (GB) 1002294.5

(51) Int. Cl. H04N 7/18

(52) U.S. Cl. 348/125; 348/E07.085

(57) ABSTRACT

An apparatus for detecting a leak in one or more blister pockets of one or more blister packs. The apparatus includes a plate for receiving the pack(s), a pressure reducer able to change the pressure around the pack(s) so as to seek to cause deflection of at least one side of the or each blister pocket between at least a first pressure and a second pressure, and an illumination source able to provide a lattice illumination on the or each blister pocket at at least the first pressure and the second pressure. The apparatus also includes an image capture device is which is able to take latticed pictures of each blister pocket at least the first pressure and the second pressure, and processor able to compare the latticed pictures to detect deflection of the blister pocket(s) at the different pressures.

The present invention relates to leak detection apparatus for blister packs, particularly but not exclusively pharmaceutical blister packs.

Currently, there are a number of methods used to detect leaks in the pockets of pharmaceutical blister packs. In one current method, a vacuum is applied across the blister pack being tested, and the rate of decompression when the vacuum is released gives an overall indication of the existence of a leak in one or more of the pockets of the blister pack. However, this method does not identify which pocket is faulty. In a second current method, individual apparatus is contacted with every pocket of a blister pack for individual testing. Whilst this will reveal individual pockets which are leaking, the overall testing procedure is time-consuming, difficult to validate, marks the pack, expensive, and limited in use.

Identification of which pocket or pockets are leaking in a blister pack is particularly desired in order to provide information on any faults or weaknesses in the manufacturing process, e.g. a fault which constantly leads to the same-positioned pocket being damaged.

Our U.S. Pat. No. 6,687,622 relates to an apparatus for detecting a leak in a blister pack using reduced pressure and a particular scanner means.

According to one aspect of the present invention, there is provided apparatus for detecting a leak in one or more blister pockets of one or more blister packs, the apparatus comprising at least:

(I) a plate for receiving the pack or packs;
(ii) a pressure reducer able to change the pressure around the pack or packs so as to seek to cause deflection of at least one side of the or each blister pocket between at least a first pressure and a second pressure;
(iii) an illumination source able to provide a lattice illumination on the or each blister pocket at at least the first pressure and the second pressure;
(iv) an image capture device able to take latticed pictures of the or each blister pocket at at least the first pressure and the second pressure; and
(v) a processor able to compare the latticed pictures at at least the first pressure and the second pressure to detect deflection of that side of the or each blister pocket at the different pressures.

In this way, the apparatus detects the deflection of each blister pocket at two or more different pressures, e.g. at atmospheric pressure, at a vacuum or near-vacuum pressure, and possibly one or more intermediate pressures.

A pressure reducer for creating and releasing a reduced pressure, such as a vacuum, therearound is well known in the art.

The illumination source could be stationary or have movement to range across the packs and/or pockets. In one embodiment, the illumination source is a stationary light able to illuminate all blister pockets, whether stationary or mobile themselves, thereunder. There could be more than one illumination source, e.g. two, one on each side of a blister pocket.

Generally the or each illumination source comprises one or more lights which emit visible illumination in a lattice or grid pattern, usually using one or more screens or masks to create said pattern. The latticing may have any suitable dimensions, shapes or patterning, generally able to provide a latticed image across at least one blister pocket.

Conveniently, the or each illumination source can be located substantially within a vacuum chamber of the apparatus of the apparatus within which the pressure reduction occurs. Alternatively, the or each illumination source can be located substantially external to a vacuum chamber of the apparatus, the or each illumination source gaining access to the vacuum chamber by means of an aperture or apertures.

The image capture device may comprise one or more of any suitable device including but not limited to a charged coupled device (CCD) camera.

Conveniently, the or each image capture device can be located substantially within a vacuum chamber of the apparatus within which the pressure reduction occurs. Alternatively, the or each image capture device can be located substantially external of a vacuum chamber of the apparatus, an aperture enabling the image capture device to gain access to the vacuum chamber.

According to one embodiment of the present invention, the processor analyses first and second pictures of the or each blister pack to produce a comparison picture wherein the comparison picture is used to detect any defects in each blister pocket of greater than a pre-determined dimension and greater than a pre-determined intensity. If any such defects are found, the blister pack could be deemed ‘rejected’ or the like.

Preferably, the apparatus is able to inspect any form of packaged medical products provided in a blister pack, including any from one or more of the group comprising: medical devices and pharmaceutical products. The present invention is useable with many different sizes, shapes and formats of pharmaceutical blister packs in particular, which can comprise blister pockets of up to 40 mm or more diameter, and different pocket depths of up to 10 mm or more, and have in-line, diagonal or asymmetric pocket formats.

The apparatus of the present invention can detect a leak in any format of blister pocket regardless of the shape of the pocket or whether the contents are tablets or capsules.

Advantageously, in accordance with the present invention the blister pack or packs may be arranged randomly on the plate without the requirement to be placed at a particular location or in a defined orientation. Similarly, where two or more packs are provided on the plate they may be placed with any mutual spacing or may partially overlap, for example at the edges of the blister packs. This enables a user of the apparatus to quickly place a blister pack, or to scatter a number of packs, to be tested on the plate thereby obviating the need to carefully position or arrange said pack or packs. Conveniently, this enables each test to be carried out quickly without any detrimental effect to the reliability or accuracy of the test results.

Advantageously, the apparatus may be provided with pack retaining means adapted to retain one or more blister packs on the plate.

The pack retaining means may comprise one or separate or integral elements or devices, able to retain and/or support one or more blister packs, said blister packs possibly being of the same, similar or of dissimilar, shapes and sizes. For example, the pack retaining means may be generic, and be able to support blister packs of any shape, size or design, or it may be specifically shaped, or comprise one or more specifically shapes elements, for one or more specific blister pack shapes.

In one embodiment, the pack retaining means comprises an over-mesh or over-net which makes light contact with at least a portion of the blister pack or packs in use, the over-mesh or over-net comprising a mesh of fine wires or strands. Contact of the pack or packs with the over-mesh or over-net is effected by moving the plate towards the over-mesh or vice versa.

In an alternative embodiment, the pack retaining means may comprise a tacky or adhesive surface or covering applied to the plate.

Optionally, the apparatus includes a drawer, preferably moveable between an open position at which the or each blister pack is changeable, and a closed position wherein the or each blister pack is suitably located within the apparatus for one or more changes in pressure to be applied therearound.

Further optionally, the plate comprises the drawer, or a portion of the drawer such as the drawer base, or is locatable in or on the drawer.

The apparatus of the present invention can be of any suitable size, shape and design so as to be able to test one or a number of blister packs simultaneously.

The apparatus may include an inscriber to mark the or each blister pocket and/or pack having a detected leak.

The apparatus of the present invention is capable of detecting holes of low sizes typically down to ten microns with time to allow pressure changes to be affected in a blister pocket.

According to a second aspect of the present invention, there is provided a method of detecting a leak in one or more blister pockets of one or more blister packs, comprising the steps of:
(a) locating the or each blister pack on or in a pack-receiving plate;
(b) providing a lattice illumination on the or each blister pocket;
(c) taking a latticed picture of the or each blister pocket at a first pressure;
(d) changing the pressure around the or each blister pack to at least a second pressure;
(e) taking a latticed picture of the or each blister pocket at the or each second pressure; and
(f) comparing the latticed pictures at the first and second pressures to detect deflection of the or each blister pocket so as to determine the presence of a leak in the or each pocket.

In one embodiment of the present invention, the method further includes measuring the intensities of at least part of the first and second pictures, and/or adjusting illumination levels of the or each source of illumination, as necessary, until the intensities of the parts of the first and second pictures are approximately the same.

Preferably, for the or each picture, pixels of the picture are analysed to determine an intensity value of each pixel, and a thresholding function is then chosen and applied to the picture, such that any pixel having an intensity value equal to or greater than the thresholding function is shown as a first colour such as white on a processed picture of the picture, and any pixel having an intensity value below the thresholding function is shown as a second colour such as black on the processed picture of the picture, or vice versa. The intensity of the pixels could be determined according to an intensity scale comprising 0 to 256.

The image processing could be one or more of the group comprising: thresholding of the or each picture, intensity inversion of the or each picture, particle filtering of the or each picture, and application of regions of interest to the or each picture.

Alternatively and/or additionally, the image processing could comprise processing the first picture to produce a processed first picture in which any defects appear bright and any features common to both the first and second pictures appear bright; processing the second picture to produce a processed second picture in which any defects appear bright and any features common to both the first and second pictures appear dark; and comparing the processed first picture and the processed second picture to produce a comparison picture in which any defects appear bright and any features common to both the first and second picture appear dark. For example, analysing pixels of the first picture to determine an intensity value of each pixel, applying a first thresholding function range to the pixels of the first picture such that any pixel of the first picture having an intensity value within this range has an intensity value in the processed first picture of 256 and any pixel of the first picture having an intensity value outside this range has an intensity value in the processed first picture of 0, or vice versa.

According to another embodiment of the present invention, there is provided a monitor screen wherein a graphical representation of one or more blister packs having one or more blister pockets undergoing a leak detection test is presentable, wherein the or each sealed blister pocket is represented by a first indicia, such as a first colour, and the or each leaking pocket is represented in a second indicia, such as a second colour.

One such indicia is the word “fail”. With colour, preferably the first colour is green and the second colour is red, although any two suitable colours can be selected

The screen presentation provides clear graphic display of test results for a non-skilled operator. Results can also be recorded or transmitted as desired or necessary.

Embodiments of the present invention will now be described by way of example only and with reference to the accompanying diagrammatic drawings in which:

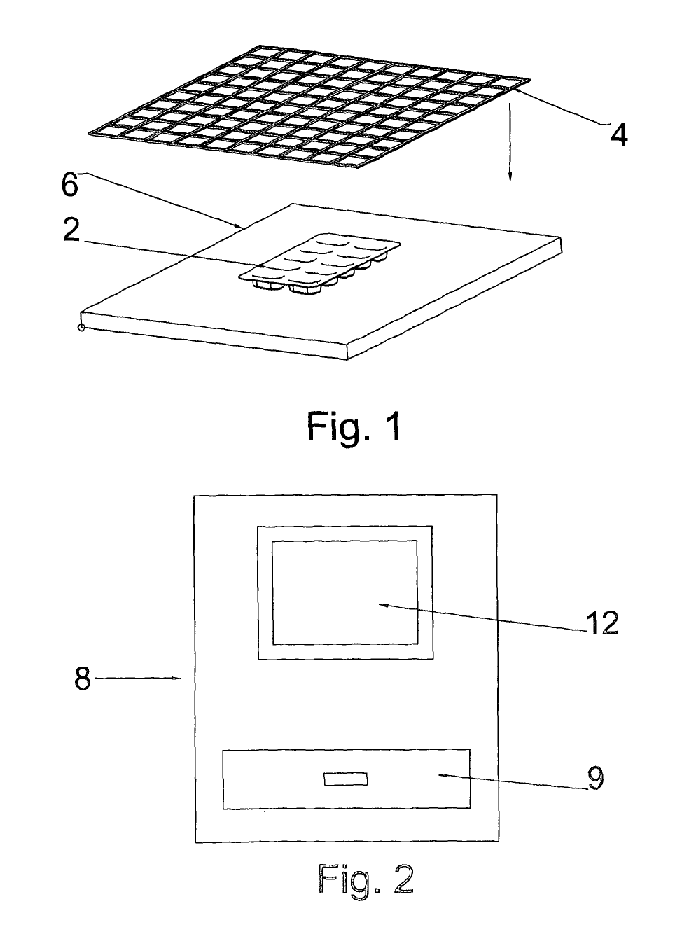

FIG. 1 is a perspective view of a pack retainer and blister pack;

FIG. 2 is a front view of housing for an apparatus according to one embodiment of the present invention;

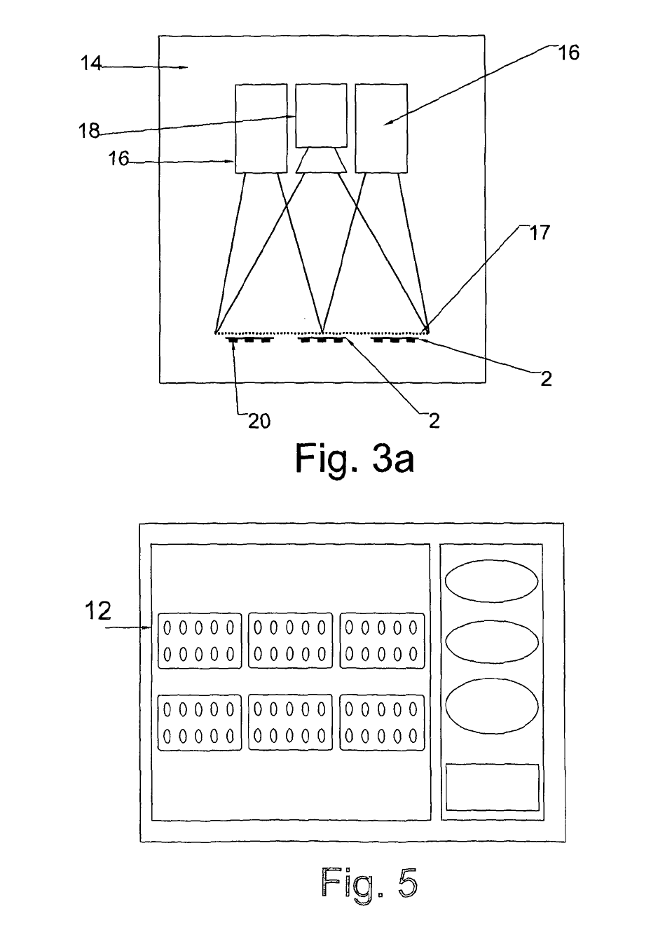

FIG. 3a is a schematic view of internal parts of an apparatus according to the present invention;

In FIG. 3b is a schematic view of internal parts of the apparatus wherein some parts are shown having an alternative arrangement.

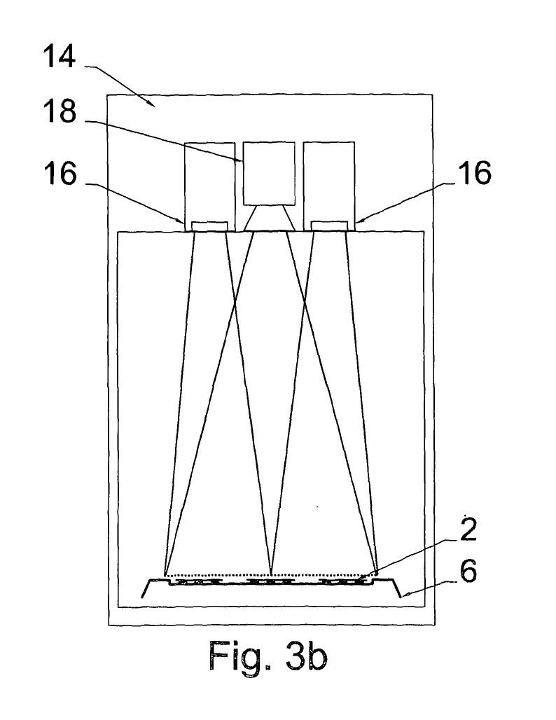

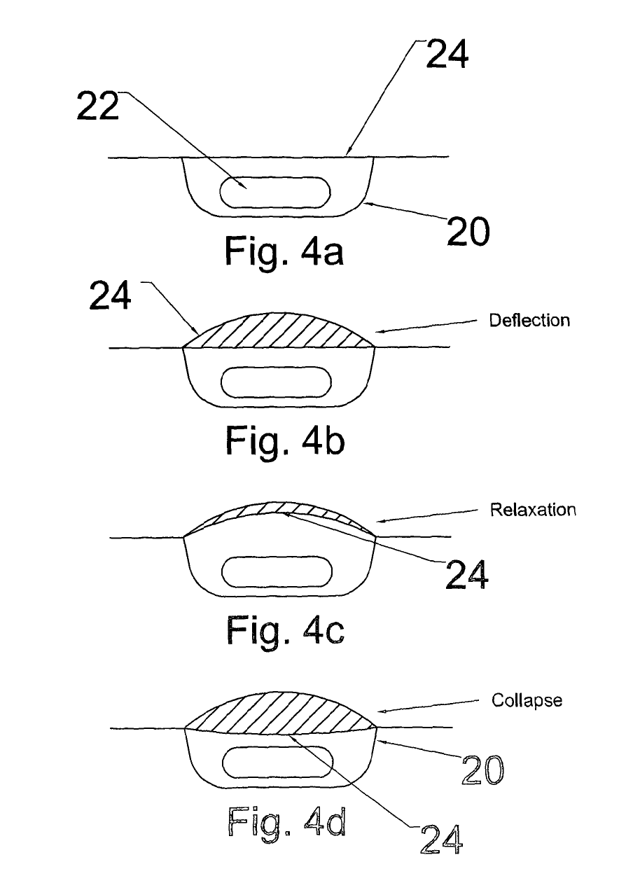

FIGS. 4a to 4d are cross-sectional side views of a blister pocket at different pressure levels and points of the leak detection process;

FIG. 5 is a view of a monitor screen according to another embodiment of the present invention;

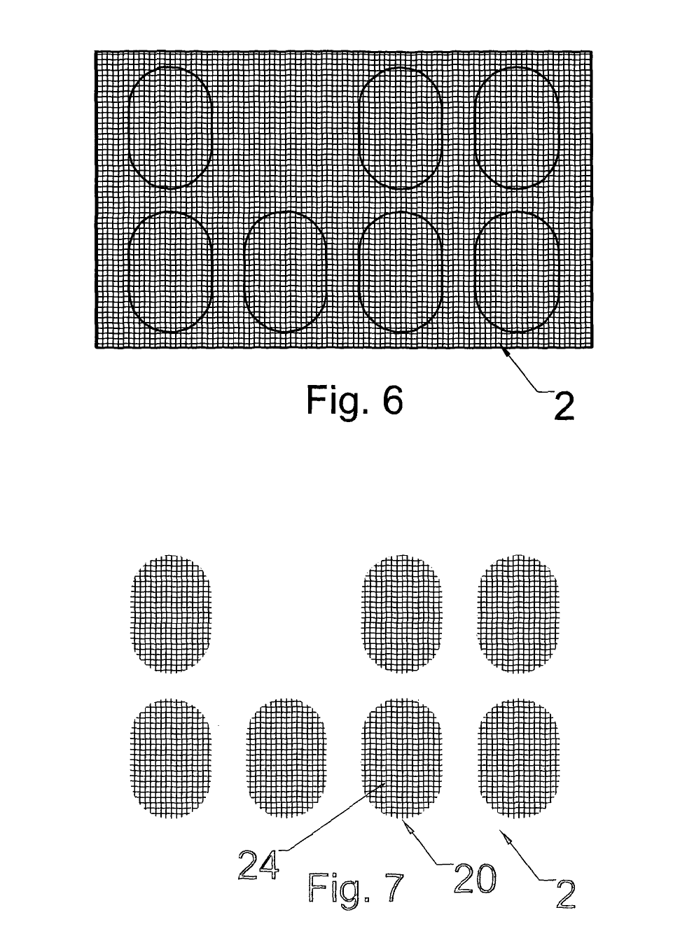

FIGS. 6 to 11 are examples of latticed pictures, comparison pictures, and graphic pictures of a blister pack following an embodiment of the method of the present invention.

Referring to the drawings, FIG. 1 shows a blister pack 2, and a pack-receiving plate 6 and a blister pack retaining means in the form of an over-mesh 4. The plate can accommodate any number of different blister packs requiring testing, and/or different shapes or sizes of blister packs and which may be arranged randomly on the plate without any requirement to be placed at a particular location or in a defined orientation. Where two or more packs 2 are provided on plate 6 they may be placed with any mutual spacing or may partially overlap, for example at the edges of the blister packs. In this way, a user of the apparatus may quickly place a blister pack 2, or scatter a number of packs 2, to be tested on plate 6 without having to carefully position or arrange said pack or packs. This enables each test to be carried out quickly and without having a detrimental effect on the reliability or accuracy of the test results. Only one blister pack is shown in FIG. 1 for clarity.

Over-mesh (or over-net) 4 provides a retaining means adapted to retain one or more blister packs 2 on plate 6, the over-mesh comprising a mesh of fine wires or strands which make light contact with at least a portion of the blister pack or packs 2 in use. Contact of the blister pack or packs 2 with the over-mesh may be effected by moving plate 6 towards over-mesh 4 or vice-versa.

Over-net 4 is just one example of a suitable blister pack retaining means adapted to prevent motion of a pack or packs when reduced pressure is applied as described below.

In an alternative embodiment, the blister pack retaining means may comprise a tacky or adhesive surface or covering applied to plate 6 and upon which a pack releasably adheres.

Other suitable pack retaining means may comprise one or separate or integral elements or devices, able to retain and/or support one or more blister packs, said blister packs possibly being of the same, similar or of dissimilar, shapes and sizes. For example, the pack retainer may be generic, and be able to support blister packs of any shape, size or design, or it may be specifically shaped, or comprise one or more specifically shapes elements, for one or more specific blister pack shapes.

FIG. 2 is a schematic view of apparatus 8 according to the present invention, having a drawer 9 being or having the plate of FIG. 1. Thus, the plate and blister pack 2 would be moveable between an open position at which the blister packs are changeable, and a closed position wherein the blister pack 2 is suitably located within the overall apparatus 8 for a change in pressure such as a vacuum to be applied therearound.

The apparatus 8 also includes a suitable air inlet and outlet (not shown), and a monitor screen 12.

FIG. 3a figuratively shows a vacuum chamber 14 in the apparatus 8 having three blister packs 2 suitably located below an illumination source, comprising two light projectors 16. The illumination provided by the light projectors 16 is a lattice illumination 17. That is, either the arrangement of the source or sources of illumination in the light projectors 16, and/or the use of one or more screens, masks, grids, etc. in front of the light projectors 16, is able to project the illumination so that it is seen in a lattice or grid-like form or pattern on the top side of the blister packs 2 facing the light projectors 16.

In this way, the view or image of the regular spacing or other geometric arrangement of the laths/lines/bars, etc. of the lattice pattern or patterning projected onto each pocket of the blister packs 2 will change (relative to the same picture-taking position) if the shape (i.e. the ‘height’) of the top side of the blister pockets 20 of the blister packs 2 changes in relation to the rest of the blister pack 2, following a change in ambient pressure. One or more of such changes in the arrangement of the lattice at different pressures can then be compared.

FIG. 3 also shows an image capture device such as a camera 18 able to take latticed pictures of the blister packs 2.

FIG. 3b figuratively shows an alternative arrangement where the camera 18 and light projectors 16 are located substantially outside vacuum chamber 14, apertures provided in the wall of the chamber enabling the camera and projectors to gain access to the vacuum chamber 14.

FIG. 4a shows a cross-sectional view of one blister pocket 20 in a blister pack 2, with a tablet 22 therein.

In use, the blister pack 2 is located in the pack retainer and drawer 9, and the drawer 9 is located in the apparatus 8. Optionally, a first latticed picture is taken by the camera 18 (FIGS. 3a, 3b) across each blister pocket 20. This first picture could provide a ‘base’ reference of which to compare future measurements. The camera 18 may also read a coding or other identifiable mark on the blister pack 2 to confirm/code the blister pack 2 being checked for reference purposes.

After any such first picture taking, a reduced pressure is applied within the apparatus 8. The reduced pressure can be wholly or substantially a vacuum. The reduction in pressure should force at least the flat side 24 of each blister pocket 20 to deflect outwardly in view of the normal pressure within the blister pocket 20. This is shown in FIG. 4b. Non-deflection of the flat side 24 of the blister pocket 20 is one indicator of a gross leak in the blister pocket 20. After a suitable period, e.g. number of seconds, to allow time for full deflection under pressure, a second latticed picture is taken by the camera 18. This second picture can be then be compared by a processor, suitably within the apparatus 8, with the first picture. As discussed hereinafter, any abnormal change in the pictures could indicate an abnormal deflection in the height of the flat side 24 of the blister pocket 20, and would therefore be an indicator of a leak.

Thereafter, a partial increase in pressure (or a partial decrease in the vacuum) could be applied within the apparatus 8 and a third latticed picture taken of the blister pack 2 once time has allowed settling of the new pressure. This could reduce the deflection in the flat side 24 of each blister pocket 20 as shown in FIG. 4c, and another picture would confirm this. However, any blister pockets 20 having a minor leak may be revealed in this way by inward deflection of the flat blister pocket side (as shown in FIG. 4d) due to the imbalance of increased pressure in the apparatus 8, but still reduced pressure within the blister pocket 20 (following the initial vacuum step).

Thereafter, pressure in the apparatus 8 is returned to the atmosphere, such that the drawer 9 is openable and the blister packs 2 removable.

On the screen 12 of the apparatus 8 can be projected an image of the blister pack 2 such as that shown in FIG. 5, which can graphically illustrate by means of ticks, crosses or colour (such as green and red) as discussed in more detail hereinafter, that or those blister packs which conform to the required deflection of their top side expected where no problem exists, and those having a different indicator where a leak was detected.

FIG. 6 shows a representative example of a first latticed picture of a blister pack 2 provided with a lattice illumination from an illumination source at at least a first pressure. For example, FIG. 6 could be a first picture taken in FIG. 4a above, prior to any change in pressure around the blister pack 2.

FIG. 7 is an image of FIG. 6 with a mask having been applied. The masked image is an example of being able to create/enhance regions of interest (i.e. the top sides 24 of the blister pockets 20) in each latticed picture taken, such as the original first picture of FIG. 6, to facilitate subsequent comparison by a processor with further pictures. The masked image allows image comparison software to pick out key features of the blister packs, and can be imported from existing drawings or images of the blister packs under testing.

FIG. 8 is a second latticed picture taken of the blister pack at at least a second pressure compared to the first picture taken at at least a first pressure and shown with a mask applied. The picture of FIG. 8 is taken at a vacuum pressure such as that shown in FIG. 4b.

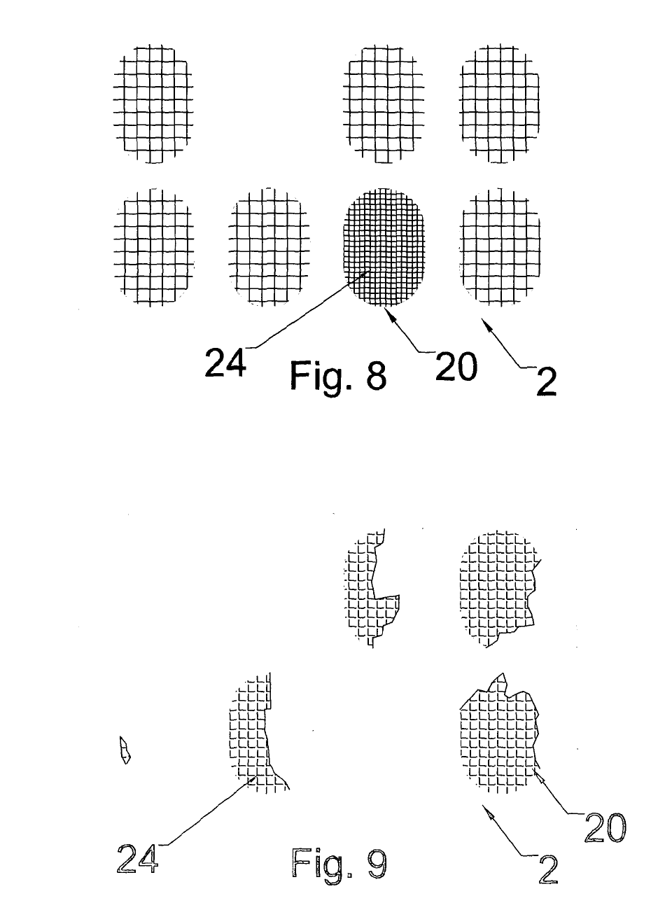

FIG. 9 is a first comparison picture or image as the result of a comparison of the latticed pictures of FIGS. 7 and 8 by a processor following the use of one or more image processing techniques, such as masking as described above, and/or using a thresholding function to highlight particular regions of the flat side 24 of the blister pack 2 that have changed shape due to becoming convex as shown in FIG. 4b. The greater the ‘white’ area shown in the first comparison picture of FIG. 9, the greater the change in the comparison of the pictures of FIGS. 7 and 8, and therefore the greater the convex change in height of the flat side 24 of the blister pockets 20 between FIGS. 4a and 4b due to the change of pressure thereinbetween.

FIG. 9 shows the blister pack inspection results with four particular blister pockets 20 exhibiting convex change as shown in FIG. 4b.

If desired, a histogram of the first comparison picture in FIG. 9 can be used to determine the ratio of black to white proportions for each blister pocket position, and the calculated ratio could be tested against a set value to determine if a gross leak is present for each blister pocket.

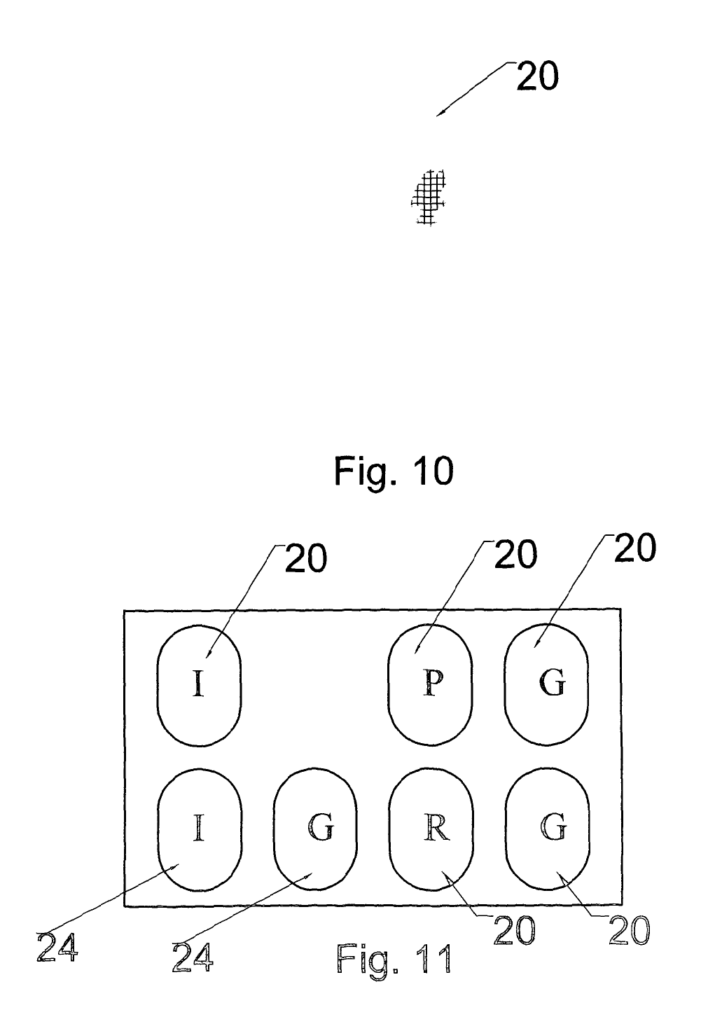

FIG. 10 is a second comparison picture between the picture of FIG. 8, and a further latticed picture taken at a reduced vacuum, for example that shown in FIG. 4d being an intermediate pressure between the ambient pressure of FIG. 4a and the vacuum pressure of FIG. 4b, generally by the relaxing of the vacuum of FIG. 4b back towards ambient pressure of FIG. 4a.

Again, FIG. 10 is a comparison picture following one or more image processing techniques, etc. as described above. FIG. 10 can be used to detect slow/small/decay leaks, generally caused by a leak being sufficiently small that an element of time is involved to appreciate the change of height of the flat side 24 of a blister pocket following a change in pressure. FIG. 10 shows one particular blister pocket 20 inspection ‘result’.

FIG. 11 is a more graphic or visual representation of the results of the comparisons between the pictures of FIGS. 6-10 to a user of the apparatus 8, and which may be provided as one section of the image on the monitor 12 shown in FIG. 5.

FIG. 11 shows a graphic representation of eight blister pockets having different shading, (and in use, generally using different colours). For example, those blister pockets 20 represented with a first shade/colour such as green (and labelled “G”) could be deemed as “good”, thereby passing the inspection; such pockets appear in FIG. 9 but not FIG. 10. That blister pocket 20 in a different shading/colour such as red (labelled “R”) could represent a gross leak, not appearing in FIG. 9. That blister pocket 20 represented by a further shade/colour such as pink (labelled “P”) could represent a decay leak, following appearance in the second comparison picture in FIG. 10.

Finally, those blister pockets 20 being another shade/colour (labelled “I”) could be ignored, as they were not sufficiently represented in original FIG. 6 to allow comparison latticed pictures.

The present invention provides a fast and convenient way to inspect a number of blisters pockets and/or packs to detect different types or forms of leaks therein, and to present the information in a suitable form for a user to understand.

In particular, the present invention provides an easy-to-use and operate testing apparatus and method able to test multiple numbers of blister packs simultaneously and in a non-destructive manner, for leaks in individual blisters from a projected grid image.

Various modifications and variations to the described embodiments of the invention will be apparent within the art without the parting of the scope of the invention testifying herein. Although the invention has been described in connection with specific preferred embodiments it should be understood that the invention as defined herein should not be unduly limited to such specific embodiment.

1. An apparatus for detecting a leak in one or more blister pockets of one or more blister packs, the apparatus comprising:
(i) a plate for receiving the pack or packs;
(ii) a pressure reducer able to change the pressure around the pack or packs so as to seek to cause deflection of at least one side of the or each blister pocket between at least a first pressure and a second pressure;
(iii) an illumination source able to provide a lattice illumination on the or each blister pocket at at least the first pressure and the second pressure;
(iv) an image capture device able to take latticed pictures of the or each blister pocket at least the first pressure and the second pressure; and
(v) a processor able to compare the latticed pictures at at least the first pressure and the second pressure to detect deflection of that side of the or each blister pocket at the different pressures.

2. The apparatus for detecting a leak in one or more blister pockets of one or more blister packs as claimed in claim 1, wherein the illumination source is a stationary illumination source able to illuminate each or all blister packs, whether stationary or mobile themselves thereunder.

3. The apparatus for detecting a leak in one or more blister pockets of one or more blister packs as claimed in claim 1, wherein the illumination source moveable to range across each or all blister packs and/or blister pockets.

4. The apparatus for detecting a leak in one or more blister pockets of one or more blister packs as claimed in claim 1, wherein the illumination source comprises one or more lights which emit visible illumination in a lattice or grid pattern.

5. The apparatus for detecting a leak in one or more blister pockets of one or more blister packs as claimed in claim 4, wherein the lattice or grid pattern is created by one or more screens or masks, the latticing or grid having dimensions, shape or patterning to provide a latticed image across at least one blister pocket.

6. The apparatus for detecting a leak in one or more blister pockets of one or more blister packs as claimed in claim 1, wherein the illumination source is located substantially within a vacuum chamber of the apparatus within which the pressure reduction occurs.

7. The apparatus for detecting a leak in one or more blister pockets of one or more blister packs as claimed in claim 1, wherein the illumination source is located substantially external of a vacuum chamber of the apparatus within which the pressure reduction occurs, the illumination source gaining access to the vacuum chamber by means of an aperture or apertures.

8. The apparatus for detecting a leak in one or more blister pockets of one or more blister packs as claimed in claim 1, wherein the image capture device comprises one or more of any suitable device including but not limited to a charged coupled device (CCD) camera.

9. The apparatus for detecting a leak in one or more blister pockets of one or more blister packs as claimed in claim 1, wherein the or each image capture device is located substantially within a vacuum chamber of the apparatus within which the pressure reduction occurs.

10. The apparatus for detecting a leak in one or more blister pockets of one or more blister packs as claimed in claim 1, wherein the image capture device is located substantially external of a vacuum chamber of the apparatus within which the pressure reduction occurs, the or each image capture device gaining access to the vacuum chamber by means of an aperture or apertures.

11. The apparatus for detecting a leak in one or more blister pockets of one or more blister packs as claimed in claim 1, wherein the processor analyses first and second pictures of the or each blister pack to produce a comparison picture wherein the comparison picture is used to detect any defects in each blister pocket of greater than a pre-determined dimension and greater than a pre-determined intensity.

12. The apparatus for detecting a leak in one or more blister pockets of one or more blister packs as claimed in claim 1, wherein the apparatus is adapted to inspect any form of packaged medical products provided in a blister pack, including any from one or more of the group comprising: medical devices and pharmaceutical products, and is useable with different sizes, shapes and formats of pharmaceutical blister having in-line, diagonal or asymmetric blister pocket formats.

13. The apparatus for detecting a leak in one or more blister pockets of one or more blister packs as claimed in claim 12, wherein the apparatus is suitable for use with blister packs comprising one or more blister pockets having a diameter of up to 40 mm or more, and/or pocket depths of up to 10 mm or more.

14. The apparatus for detecting a leak in one or more blister pockets of one or more blister packs as claimed in claim 1, wherein the or each blister pack may be arranged randomly on the plate without the requirement to be placed at a particular location or in a defined orientation.

15. The apparatus for detecting a leak in one or more blister pockets of one or more blister packs as claimed in claim 1, wherein two or more blister packs may be provided on the plate at any mutual spacing or in partial overlapping fashion.

16. The apparatus for detecting a leak in one or more blister pockets of one or more blister packs as claimed in claim 1, wherein the apparatus is further provided with blister pack retaining means adapted to retain one or more blister packs on the plate.

17. The apparatus for detecting a leak in one or more blister pockets of one or more blister packs as claimed in claim 16, wherein the blister pack retaining means comprises one or separate or integral elements or devices, adapted to retain and/or support one or more blister packs, said blister packs possibly being of the same, similar or of dissimilar, shapes and sizes.

18. The apparatus for detecting a leak in one or more blister pockets of one or more blister packs as claimed in claim 16, wherein the pack retaining means comprises an over-mesh or over-net which makes light contact with at least a portion of the blister pack or packs in use.

19. The apparatus for detecting a leak in one or more blister pockets of one or more blister packs as claimed in claim 18, wherein the over-mesh or over-net comprises a mesh of fine wires or strands.

20. The apparatus for detecting a leak in one or more blister pockets of one or more blister packs as claimed in claim 18, wherein contact of the pack or packs with the over-mesh or over-net is effected by moving the plate towards the over-mesh or vice versa.

21. The apparatus for detecting a leak in one or more blister pockets of one or more blister packs as claimed in claim 17, wherein the pack retaining means comprises a tacky or adhesive surface or covering applied to the plate.

22. The apparatus for detecting a leak in one or more blister pockets of one or more blister packs as claimed in claim 1, wherein the apparatus includes a drawer moveable between an open position at which the or each blister pack is changeable, and a closed position wherein the or each blister pack is suitably located within the apparatus for one or more changes in pressure to be applied therearound.

23. The apparatus for detecting a leak in one or more blister pockets of one or more blister packs as claimed in claim 22, wherein the plate comprises the drawer, or a portion of the drawer such as the drawer base, or is locatable in or on the drawer.

24. The apparatus for detecting a leak in one or more blister pockets of one or more blister packs as claimed in claim 1, wherein the apparatus further comprises an inscriber to mark the or each pocket and/or pack having a detected leak.

25. The apparatus for detecting a leak in one or more blister pockets of one or more blister packs as claimed in claim 1, wherein the apparatus can detects holes of low sizes typically down to ten microns with time to allow pressure changes to be affected in a pocket.

26. A method of detecting a leak in one or more blister pockets of one or more blister packs, comprising the steps of:
(a) locating the or each blister pack on or in a pack-receiving plate;
(b) providing a lattice illumination on the or each blister pocket;
(c) taking a latticed picture of the or each blister pocket at a first pressure;
(d) changing the pressure around the or each blister pack to at least a second pressure;
(e) taking a latticed picture of the or each blister pocket at the or each second pressure; and
(f) comparing the latticed pictures at the first and second pressures to detect deflection of the or each blister pocket so as to determine the presence of a leak in the or each pocket.

27. The method of detecting a leak in one or more blister pockets of one or more blister packs as claimed in claim 26, wherein the method further includes the step of measuring the intensities of at least part of the first and second pictures, and/or adjusting illumination levels of the or each source of illumination, as necessary, until the intensities of the parts of the first and second pictures are approximately the same.

28. The method of detecting a leak in one or more blister pockets of one or more blister packs as claimed in claim 26, wherein for the or each picture, pixels of the picture are analysed to determine an intensity value of each pixel, and a thresholding function is chosen and applied to the picture, such that any pixel having an intensity value equal to or greater than the thresholding function is shown as a first colour s on a processed picture of the picture, and any pixel having an intensity value below the thresholding function is shown as a second colour on the processed picture of the picture, or vice versa.

29. The method of detecting a leak in one or more blister pockets of one or more blister packs as claimed in claim 28, wherein the intensity of the pixels is determined according to an intensity scale comprising 0 to 256.

30. The method of detecting a leak in one or more blister pockets of one or more blister packs as claimed in claim 28, wherein the image processing comprises one or more of the group comprising:
thresholding of the or each picture, intensity inversion of the or each picture, particle filtering of the or each picture, and application of regions of interest to the or each picture.

31. The method of detecting a leak in one or more blister pockets of one or more blister packs as claimed in claim 26, wherein the image processing additionally or alternatively comprises the steps of:
processing the first picture to produce a processed first picture in which any defects appear bright and any features common to both the first and second pictures appear bright; processing the second picture to produce a processed second picture in which any defects appear bright and any features common to both the first and second pictures appear dark; and comparing the processed first picture and the processed second picture to produce a comparison picture in which any defects appear bright and any features common to both the first and second picture appear dark.

32. An apparatus and method of detecting a leak in one or more blister pockets of one or more blister packs as claimed in claim 26, wherein a graphical representation of one or more blister packs having one or more blister pockets undergoing a leak detection test is displayed on a monitor screen of the apparatus, wherein the or each sealed blister pocket is represented by a first indicia, such as a and the or each leaking pocket is represented in a second.

33. The apparatus and method of detecting a leak in one or more blister pockets of one or more blister packs as claimed in claim 32, wherein the first and second indicia comprise different colours or text.

34. (canceled)
